(19) United States
(12) Patent Application Publication
(10) Pub. No.: US 2008/0286512 A1
(43) Pub. Date: Nov. 20, 2008

(54) MULTILAYERED LAMINATE FOR TUBES HAVING AN EMBEDDED ALUMINUM LAYER, A PROCESS FOR THE PRODUCTION THEREOF AND A TUBE PRODUCED THEREFROM

(76) Inventors: Arno Holzmuller, Kempten (DE); Detlev Schulz, Dietmannsried (DE)

Correspondence Address: KNOBBE MARTENS OLSON & BEAR LLP, 2040 MAIN STREET, FOURTEENTH FLOOR, IRVINE, CA, 92614, US

(21) Appl. No.: 12/121,708

(22) Filed: May 15, 2008

(30) Foreign Application Priority Data
May 18, 2007 (DE) 10 2007 023 221.9
Jun. 18, 2007 (DE) 10 2007 027 873.1

(51) Int. Cl. B32B 15/08; B29C 63/18

(52) U.S. Cl. 428/35.9; 428/457; 428/461; 428/458; 428/339; 264/171.27

(57) ABSTRACT

The invention relates to a multilayered laminate for tubes having an embedded aluminum layer, the aluminum layer being surrounded on each side by an oriented co-extruded protective layer which is in each case joined to the aluminum layer by means of an intermediate layer material. The invention relates also to the production of such a laminate and to a tube produced from such a laminate.

### CROSS-REFERENCE TO RELATED APPLICATIONS

This application is a U.S. patent application which claims priority to German Application No. DE 10 2007 023 221.9 filed May 18, 2007 and to German Application No. DE 10 2007 027 873.1 filed Jun. 18, 2007, the entire contents of which is hereby incorporated by reference herein in their entirety

### BACKGROUND OF THE INVENTION

The invention relates to a multilayered laminate for tubes having an embedded aluminum layer, to a process for the production thereof and to a tube produced therefrom, for example in accordance with the preambles of claims 1, 13 and 17 herein.

Multilayered laminates are required in the packaging industry sector. They exhibit flexible to relatively dimensionally stable properties, according to the thickness of the laminate, and are used inter alia for the production of tubes, bags and other packagings. Multilayered laminates which have an embedded aluminum foil are especially suitable for the packaging of aroma-containing substances. That is based on the fact that an aluminum foil present in the laminate acts as a blocking layer for numerous substances, especially volatile substances. It has proved to be a problem, however, that the aluminum layer is attacked by aggressive substances, such as, for example, acids and aggressive organic substances, so that it is necessary to shield the aluminum layer from the contents of the tube. That was done hitherto by using strong materials of accordingly high thickness for the layers covering the aluminum layer; so that the aggressive substance in question had to cover1 a longer diffusion path. Furthermore, the aluminum layer was shielded from the contents of the packaging optionally by means of an additional barrier layer, for1 example of ethylene vinyl alcohol copolymer (EVOH).

The necessity to use such thick laminate layers means, however, that the multilayered laminate becomes very thick as a result of the accumulation of the individual layer thicknesses and, not least, becomes expensive on account of the large amount of material being used.

For example, the thicknesses of the laminates used, for example in the field of toothpaste tubes, are in the range of the order of a quarter of a millimetre, which results in thicknesses of half a millimetre in the seal regions. That high layer thickness has an adverse effect, both aesthetically and practically, in all regions of a tube in which overlapping of the laminate is necessary. Such overlapping is necessary, for example, for the production of a tubular lap-seal body from a flat laminate blank.

A further disadvantage of previous laminates is the risk of delamination, which is naturally the higher, the greater the sensitivity of the materials used to the particular contents of a tube.

Furthermore, the haptic properties of the laminates known hitherto are also unsatisfactory, which is likewise attributable essentially to the necessary high layer thicknesses of previously known laminates, because such thicknesses always impart a certain stiffness to the article made from such a laminate.

### SUMMARY OF THE INVENTION

The problem underlying the invention is to provide a multilayered laminate having an embedded aluminum layer and the production thereof and packagings produced therefrom, which provides improved barrier properties combined at the same time with thinner layer thicknesses of the individual laminate layers, which exhibits advantageous producibility and individually improved printability and which furthermore offers improved haptic properties as well as improved environmental compatibility.

That problem is solved by a multilayered laminate, for example according to claim 1 and by a process for the production of such a laminate, for example according to claim 13 and by a tube produced from such a laminate, for example according to claim 17 herein.

In particular, the problem is solved by a multilayered laminate for tubes having an embedded aluminum layer, the aluminum layer being surrounded on each side by

an oriented co-extruded protective layer which is in each case joined to the aluminum layer by means of an intermediate layer′ material.

An important concept of the invention is that the aluminum layer is surrounded by the intermediate layer material and is joined thereby to the oriented co-extruded protective layer. Accordingly, both the intermediate layer material and the oriented co-extruded protective layer protect the aluminum layer both from the mechanical standpoint and in respect of diffusible substances, because to reach the aluminum layer those substances, starting from the side of the laminate facing the inner side of a tube, have to diffuse first through the oriented co-extruded protective layer and then through the intermediate layer material.

The oriented co-extruded protective layer, in the same way as the intermediate layer material, is present on each side of the aluminum layer so that the aluminum layer is protected against an influx of aggressive substances both from the interior of a future tube and from its exterior.

According to the invention, the co-extruded protective layer is of at least two-ply construction and comprises at least one oriented polymer layer and at least one, optionally two or more, cover layer(s). The cover layers, which are also referred to as skin layers, surround the polymer layer and are themselves printable on their side remote from the polymer layer. Those cover layers are also of sealable construction, so that lap-seal sealing or fin-seal sealing of such a laminate is readily possible.

According to the invention, the protective layer is co-extruded, the polymer layer and cover layer(s) being extruded and joined together in one operation. After application of the cover layer(s), the co-extruded protective layer is stretched, especially biaxially, so that after the stretching operation the entire protective layer is oriented. That relates also to the cover layer(s).

According to the invention, the intermediate layer′ material A facing the outer side of the tube is of at least single-ply construction, but is preferably of multi-ply, especially single-ply to three-ply, construction, and comprises alternatively or in combination a first, a second and a third bonding layer1.

The intermediate layer material I facing the inner side of the tube is of at least single-ply construction, preferably of multi-ply, especially single-ply to five-ply construction, with from one to three plies thereof having alternatively or in combination the material of the first, the second and/or the third bonding layer.

Furthermore, in accordance with one embodiment the intermediate layer material I facing the inner side of the tube comprises at least one barrier layer which has an adhesive layer, especially a layer of an adhesive agent, on at least one side. That adhesive layer′ ensures that the barrier layer in integrated into the intermediate layer material I in an optimum way and has an optimum bond to the layers surrounding the barrier layer,

The materials used according to the invention are listed in the following table and in each case can be present in the respective layer alone or in combination.

| Layer | Material(s) |
|---|---|
| Cover layer (10) | Polyethylene (PE), polypropylene (PP), poly- |
| | ethylene terephthalate (PETP), polyethylene |
| | terephthalate glycol (PETG), mixtures of the |
| | afore-mentioned materials |
| Oriented polymer | Polypropylene (PP), polyethylene terephthalate |
| layer (20) | (PET) |
| First bonding | Maleic acid anhydride (MSA), ethylene |
| layer (43) | methacrylate (EMA), ethyleneacrylic acid |
| | copolymers (EAA), ionomers, terpolymers |
| | (ethyleneacrylic acid-maleic acid |
| | ester anhydrides), ethylene vinyl acetates |
| | (EVA), modified olefins, mixtures of the |
| | afore-mentioned materials |
| Second bonding | Maleic acid anhydride (MSA), ethylene |
| layer (45) | methacrylate (EMA), ethyleneacrylic acid |
| | copolymers (EAA), ionomers, terpolymers |
| | (ethyleneacrylic acid-maleic acid |
| | ester anhydrides), ethylene vinyl acetates |
| | (EVA), polyolefins, especially polyethylene |
| | (PE), polypropylene (PP), modified olefins, |
| | mixtures of the afore-mentioned materials |
| Third bonding | Maleic acid anhydride (MSA), ethylene |
| layer (47) | methacrylate (EMA), ethyleneacrylic acid |
| | copolymers (EAA), ionomers, terpolymers |
| | (ethyleneacrylic acid-maleic acid ester |
| | anhydrides), ethylene vinyl acetates (EVA), |
| | polyolefins, especially polyethylene (PE), |
| | polypropylene (PP), modified olefins, mixtures |
| | of the afore-mentioned materials |
| Adhesive layer (60) | Maleic acid anhydride (MSA), ethylene |
| | methacrylate (EMA), ethyleneacrylic acid |
| | copolymers (EAA), ionomers, terpolymers |
| | (ethyleneacrylic acid-maleic acid ester |
| | anhydrides), ethylene vinyl acetates (EVA), |
| | modified olefins, mixtures of the afore-mentioned |
| | materials |
| Barrier layer (70) | Polyamide (PA), especially amorphous and/or |
| | aromatic and/or partially aromatic polyamide, |
| | ethylene vinyl alcohol copolymer (EVOH), poly- |
| | acrylonitrile (PAN), polyethylene |
| | terephthalate (PET), mixtures of the afore- |
| | mentioned materials |

The respective layer thicknesses of the individual layers can be found in the following table:

| | | | Especially |
|---|---|---|---|
| | | Layer thickness | preferred |
| Layer | Layer thickness | preferably | layer thickness |
| Cover layer | 0.5 μm-10 μm | 0.8 μm-6 μm | 1 μm-2.5 μm |
| (10) | | | |
| Oriented | 10 μm-100 μm | 15 μm-80 μm | 30 μm-50 μm |
| polymer layer | | | |
| (20) | | | |
| Aluminum | 3 μm-70 μm | 8 μm-35 μm | 10 μm-25 μm |
| layer (50) | | | |
| First bonding | 5 μm-140 μm | 8 μm-95 μm | 10 μm-50 μm |
| layer (43) | | | |
| Second | 5 μm-140 μm | 8 μm-95 μm | 10 μm-50 μm |
| bonding layer | | | |
| (45) | | | |
| Third bonding | 5 μm-140 μm | 8μm-95 μm | 10 μm-50 μm |
| layer (47) | | | |
| Adhesive layer | 1.5 μm-25 μm | 3 μm-18 μm | 4.5 μm-12 μm |
| (60) | | | |
| Barrier layer | 3 μm-60 μm | 3.8 μm-40 μm | 4 μm-28 μm |
| (70) | | | |

By virtue of the multilayered construction of the intermediate layer material, both in respect of the side facing the inner side of the tube and in respect of the side facing the outer side of the tube it is possible to combine materials the positive properties of which have an additive effect and in that way offer an intermediate layer material which, on the one hand, has both high mechanical stability and high chemical stability. In particular, mention should be made in this connection of a high degree of stretchability combined at the same time with high tear resistance, a high level of resistance to diffusion and the possibility of achieving good grip and, at the same time, good haptic properties.

The provision of the oriented co-extruded protective layer according to the invention also provides good external stability combined simultaneously with good sealability and, resulting therefrom, high stability of the seals and accordingly optimised printability of the tube produced therefrom.

According to the invention it is also possible to print on an outer cover layer facing the outer side of the tube. Furthermore, the inner cover layer facing the outer side of the tube or facing the inner side of the tube can be printed on its side facing the intermediate layer material A by means of a so-called “reverse print”. That is possible because, according to the invention, the polymer layer arranged between the cover layer1 can be transparent

For the case where the application of a “reverse print” is desired, a further adhesive layer is preferably provided between the colour layer, which is arranged on the inner cover layer, and the intermediate layer material A in order to ensure good adhesion of the colour layer to the intermediate layer material. By the use of the materials according to the invention it is possible to create layer thicknesses in the indicated thickness ranges and in that way to achieve a laminate thickness considerably thinner than in the prior art, the multilayered laminate simultaneously having improved barrier properties as well as optimised mechanical and chemical properties.

The production of the intermediate layer material according to the invention is effected by joint extrusion of the layers forming the intermediate layer material, it being possible to produce the laminate in the course of a tandem extrusion, one side of the aluminum layer being coated in a first extrusion step and the other side of the aluminum layer being coated in a second extrusion step. Those extrusion steps can be carried out as co-extrusion steps, a multi-ply composite of layers being extruded simultaneously.

Furthermore, the problem according to the invention is solved by a process for the production of a multilayered laminate for tubes having an embedded aluminum layer, the aluminum layer′ being coated on each side with intermediate layer material and with a co-extruded protective layer. The oriented co-extruded protective layer is in turn produced by at least one-sided coating, especially co-extrusion, of the polymer layer with a cover′ layer. Preferably the polymer layer is coated with a cover layer on each side. After coating of the polymer layer with the respective associated cover layer, the resultant protective layer is stretched, especially biaxially.

Furthermore, the layers forming the intermediate layer material are co-extruded and/or extruded immediately one after the other to form the laminate.

Moreover, the problem according to the invention is also solved by a tube produced from a laminate as detailed above.

The invention will be described below on the basis of exemplary embodiments which are explained in greater detail with reference to the Figures.

### BRIEF DESCRIPTION OF THE DRAWINGS

FIG. 1 is a diagrammatic view of a first embodiment of a laminate according to the invention;

FIG. 2 is a diagrammatic view of a further embodiment of a laminate according to the invention;

FIG. 3 is a diagrammatic view of a further embodiment of a laminate according to the invention;

FIG. 4 is a diagrammatic view of a further embodiment of a laminate according to the invention;

FIG. 5 to 7 are diagrammatic views of further embodiments of laminates according to the invention based on the embodiments according to FIG. 1, FIG. 2 and FIG. 4, but with an additional barrier layer.

### DETAILED DESCRIPTION OF THE PREFERRED EMBODIMENT

In the description which follows, parts that are the same or have the same action have been given the same reference numerals.

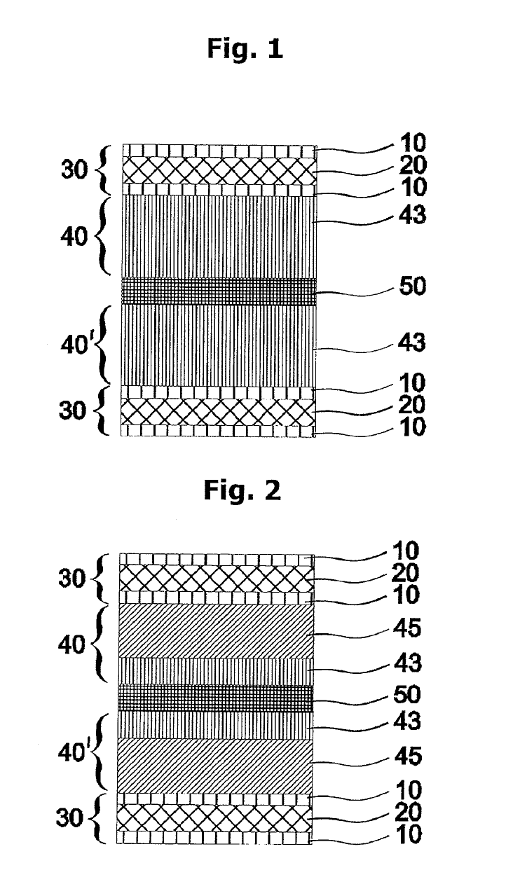

FIG. 1 is a diagrammatic view of the simplest form of a laminate according to the invention, an aluminum layer 50 being coated, in the direction of the outer side of a tube in the case where a tube is being formed, with an intermediate material layer A 40, followed by a co-extruded protective layer 30 which, in turn, consists of a central oriented polymer layer 20 covered on each side by a cover layer 10. In the direction of a notional inner side of the tube, the aluminum layer 50 is adjoined by an intermediate layer material I 40′ which, in turn, is adjacent to a cover layer 10 which is in turn arranged next to an oriented polymer layer 20. As a layer adjacent to that polymer layer 20 there is again provided a cover layer 10. Accordingly, this laminate according to the invention is constructed symmetrically in respect of the arrangement of layers in relation to the aluminum layer 50. In accordance with this embodiment, the aluminum layer has a layer thickness of 12 μm, while the intermediate layer material A 40 has a layer thickness of 40 um, The intermediate layer material I 40′ has a thickness of 50 μm. The two external co-extruded protective layers 30 each have a layer thickness of 30 μm, the oriented polymer layer 20 having a thickness of 22 μm and the respective cover′ layers 10 each having a thickness of 2 μm.

FIG. 2 differs from FIG. 1 to the extent that the two intermediate layer materials A and I do not consist only of a first bonding layer 43, but both the intermediate layer material A 40 and the intermediate layer material I 40′ are made of a first bonding layer 43 and a second bonding layer 45, the second bonding layer 45 having a layer thickness of 34 μm in each case, while the two first bonding layers 43 each have a layer thickness of 14 μm.

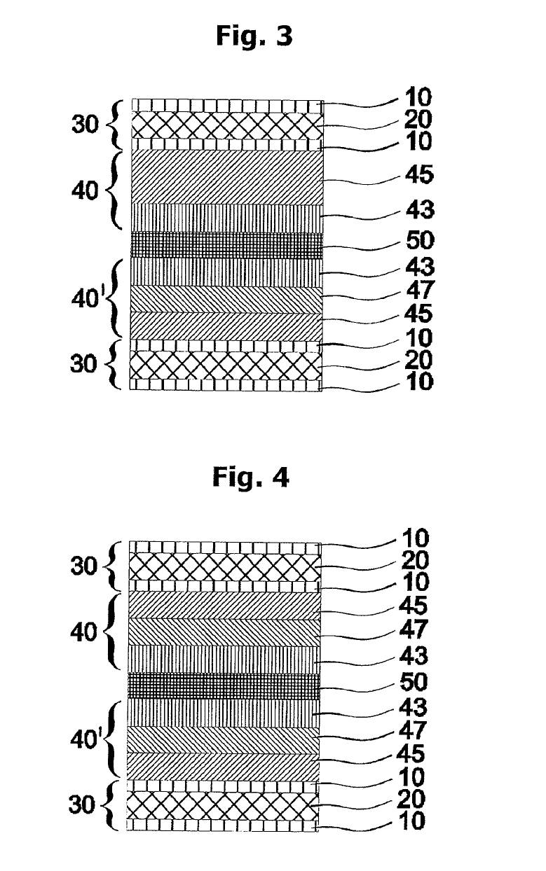

According to FIG. 3, the intermediate layer material I 40′ is further divided into a first bonding layer 43 having a layer thickness of 14 μm, a second bonding layer 45 having a layer thickness of 17 μm and a third bonding layer 47 having a layer thickness of 30 μm. Accordingly, the intermediate layer material I 40′ has a total layer thickness of only 65 μm, which makes for significantly improved flexibility of the laminate according to the invention as well as for improved sealability combined simultaneously with a very high barrier property.

The embodiment according to FIG. 4 corresponds substantially to the embodiment according to FIG. 3 except that the outer intermediate material layer A 40 also has a three-ply structure comprising a first bonding layer 43, a second bonding layer 45 and a third bonding layer 47.

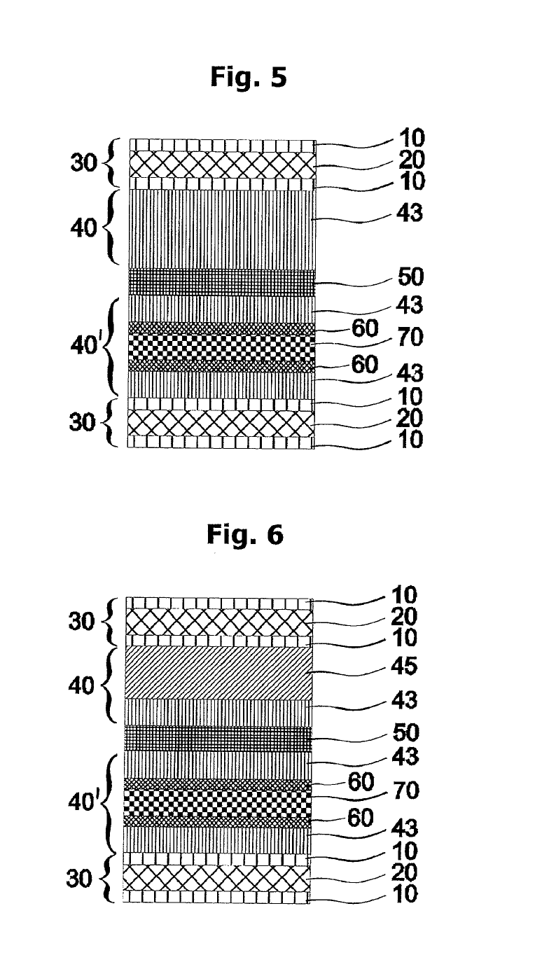

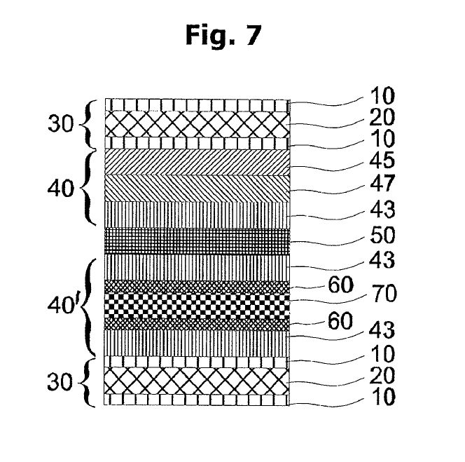

FIGS. 5, 6 and 7 correspond to the embodiments according to FIGS. 1, 2 and 4 in terms of their outer structure relative to the aluminum layer 50. The inner structure of the laminate has been modified to the effect that a barrier layer 70 has been integrated into a first bonding layer 43 forming the intermediate layer material I 40′, which barrier layer is surrounded on each side by an adhesive layer 60.

Materials that come into consideration for the layers indicated include the materials mentioned above, it being emphasised that adjacent layers preferably contain different proportions of a certain substance.

It should be pointed out here that all the above-described parts, considered alone and in any combination, especially the details shown in the drawings, are claimed as being important to the invention. Modifications thereof will be familiar1 to the person skilled in the art.

### LIST OF REFERENCE NUMERALS

10 cover layer
20 oriented polymer layer
30 co-extruded protective layer
40 intermediate layer material A
40′ intermediate layer material I
43 first bonding layer
45 second bonding layer
47 third bonding layer
50 aluminum layer
60 adhesive layer
70 barrier layer

What is claimed is:

1. Multilayered laminate for tubes having an embedded aluminum layer, wherein the aluminum layer is surrounded on each side by an oriented co-extruded protective layer which is in each case joined to the aluminum layer by means of an intermediate layer material.

2. Multilayered laminate according to claim 1, wherein the co-extruded protective layer is at least two-ply and comprises at least one oriented polymer layer and at least one cover layer.

3. Multilayered laminate according to claim 1, wherein the co-extruded protective layer is stretched, especially biaxially.

4. Multilayered laminate according to claim 1, wherein the intermediate layer material facing the outer1 side of the tube is at least single-ply, preferably multi-ply, especially single-ply to three-ply, and comprises alternatively or in combination a first, a second and a third bonding layer.

5. Multilayered laminate according to claim 1, wherein the intermediate layer material facing the inner side of the tube comprises at least single-ply, preferably multi-ply, especially single-ply to five-ply, with from one to three plies thereof having alternatively or in combination the material of the first, the second and/or the third bonding layer.

6. Multilayered laminate according to claim 1, wherein the intermediate layer material comprises at least one barrier layer, which has an adhesive layer, especially a layer of an adhesive agent, on at least one side.

7. Multilayered laminate according to claim 1, wherein the respective layers have materials in accordance with the following in each case alone or in combination, the laminate comprising
at least one cover layer comprising material selected from the group consisting of: Polyethylene (PE), polypropylene (PP), polyethylene terephthalate (PETP), polyethylene terephthalate glycol (PETG), mixtures of the afore-mentioned materials;
at least one oriented polymer layer comprising material selected from the group consisting of: Polypropylene (PP), polyethylene terephthalate (PET);
at least one first bonding layer comprising material selected from the group consisting of: Maleic acid anhydride (MSA), ethylene methacrylate (EMA), ethyleneacrylic acid copolymers (EAA), ionomers, terpolymers (ethyleneacrylic acid-maleic acid ester anhydrides), ethylene vinyl acetates (EVA), modified olefins, mixtures of the afore-mentioned materials;
at least one second bonding layer comprising material selected from the group consisting of: Maleic acid anhydride (MSA), ethylene methacrylate (EMA), ethyleneacrylic acid copolymers (EAA), ionomers, terpolymers (ethyleneacrylic acid-maleic acid ester anhydrides), ethylene vinyl acetates (EVA), polyolefins, especially polyethylene (PE), polypropylene (PP), modified olefins, mixtures of the afore-mentioned materials;
at least one third bonding layer comprising material selected from the group consisting of: Maleic acid anhydride (MSA), ethylene methacrylate (EMA), ethyleneacrylic acid copolymers (EAA), ionomers, terpolymers (ethyleneacrylic acid-maleic acid ester anhydrides), ethylene vinyl acetates (EVA), polyolefins, especially polyethylene (PE), polypropylene (PP), modified olefins, mixtures of the afore-mentioned materials;
at least one adhesive layer comprising material selected from the group consisting of: Maleic acid anhydride (MSA), ethylene methacrylate (EMA), ethyleneacrylic acid copolymers (EAA), ionomers, terpolymers (ethyleneacrylic acid-maleic acid ester anhydrides), ethylene vinyl acetates (EVA), modified olefins, mixtures of the afore-mentioned materials; and
at least one barrier layer comprising material selected from the group consisting of: Polyamide (PA), especially amorphous and/or aromatic and/or partially aromatic polyamide, ethylene vinyl alcohol copolymer (EVOH), poly-acrylonitrile (PAN), polyethylene terephthalate (PET), mixtures of the afore-mentioned materials.

8. Multilayered laminate according to claim 1, wherein the respective layers have a thickness in accordance with the following, the laminate company
at least one cover layer having a thickness of 0.5 μm to 10 μm;
at least one oriented polymer layer having a thickness of 10 μm to 100 μm;
at least one aluminum layer having a thickness of 3 μm to 70 μm;
at least one first bonding layer having a thickness of 5 μm to 140 μm
at least one second bonding layer having a thickness of 5 μm to 140 μm;
at least one third bonding layer having a thickness of 5 μm to 140 μm;
at least one adhesive layer having a thickness of 1.5 μm to 25 μm; and
at least one barrier layer having a thickness of 3 μm to 60 μm;

9. Multilayered laminate according to claim 2, wherein the cover layer is an outer layer facing the outer side of the tube and is printable.

10. Multilayered laminate according to claim 2, wherein the cover layer as an inner layer facing the outer side of the tube and is printable on its side facing the intermediate layer material.

11. Multilayered laminate according to claim 10, wherein an adhesive layer is provided between a colour layer, which is arranged on the inner cover layer, and the intermediate layer material.

12. Multilayered laminate according to claim 1, wherein the layers forming the intermediate layer material are extruded, especially produced by means of tandem extrusion.

13. Process for the production of a multilayered laminate for tubes having an embedded aluminum layer, wherein the aluminum layer is coated on each side with intermediate layer material and with a co-extruded protective layer.

14. Process according to claim 13, wherein the co-extruded protective layer is produced by at least one-sided coating, especially co-extrusion, of a polymer layer with a cover layer.

15. Process according to claim 13, wherein the co-extruded protective layer is stretched, especially biaxially.

16. Process according to claim 13, wherein the layers forming the intermediate layer material are especially co-extruded and/or extruded immediately one after the other to form the laminate.

17. Tube produced from a laminate according to claim 13.
